(19) United States
(12) Patent Application Publication
(10) Pub. No.: US 2005/0223086 A1
(43) Pub. Date: Oct. 6, 2005

(54) Discovering nearby hosts and applications for impromptu interactions using well-known ad-hoc network configuration

(76) Inventors: Pierre Guillaume Raverdy, Paris (FR); Atsushi Shionozaki, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/815,301

(22) Filed: Mar. 31, 2004

(51) Int. Cl. G06F 15/177

(52) U.S. Cl. 709/220

(57) ABSTRACT

An embodiment of the present invention includes a technique to allow mobile devices to discover nearby hosts and applications for impromptu interactions. A session-based ad-hoc group (SBG) is created within a well-known ad-hoc group (WKG) for impromptu interactions among unrelated mobile users. The WKG has a WKG network configuration and a set of WKG interaction protocols. The SBG has SBG network configuration and a set of SBG interaction protocols. Information pertaining to the SBG is advertised on the WKG.

### BACKGROUND

1. Field of the Invention

Embodiments of the invention relates to the field of wireless fidelity (WiFi), and more specifically, to WiFi host discovery.

2. Description of Related Art

With current WiFi deployment schemes, mobile users use their WiFi enabled devices around access points, or hotspots, that are either open or require a registration to a specific wireless Internet service provider (WISP). The predicted or expected usages are access to Internet services such as e-mail access, Web browsing, or Virtual Private Network (VPN) to corporate networks, or peer-to-peer (P2P) interactions among nearby users.

There are several problems in the existing WiFi systems. First, access points are not available everywhere. A group of users may not be able to interact even if they are within range of each other. Second, access points are usually fixed in location. Therefore, they cannot support a network for a group of mobile users that go out of range. Third, many commercial access points require user registration, which usually involves a payment of fees. Fourth, all users associated with an access point use the same frequency, leading to bandwidth allocation problems and frequency interferences.

### BRIEF DESCRIPTION OF THE DRAWINGS

The invention may best be understood by referring to the following description and accompanying drawings that are used to illustrate embodiments of the invention. In the drawings:

FIG. 1 is a diagram illustrating a system in which one embodiment of the invention can be practiced.

FIG. 2 is a diagram illustrating a well-known group (WKG) according to one embodiment of the invention.

FIG. 3 is a diagram illustrating a session-based group (SBG) according to one embodiment of the invention.

FIG. 4 is a diagram illustrating an advertisement protocol according to one embodiment of the invention.

FIG. 5 is a diagram illustrating a set of interaction protocols according to one embodiment of the invention.

FIG. 6 is a diagram illustrating a computer system according to one embodiment of the invention.

### DESCRIPTION

An embodiment of the present invention includes a technique to allow mobile devices to discover nearby hosts and applications for impromptu interactions. A session-based ad-hoc group (SBG) is created within a well-known ad-hoc group (WKG) for impromptu interactions among unrelated mobile users. The WKG has a WKG network configuration and a set of WKG interaction protocols. The SBG has an SBG network configuration and a set of SBG interaction protocols. Information pertaining to the SBG is advertised on the WKG.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

One embodiment of the invention aims at increasing the chance of user interaction in mobile scenarios. If a user can discover other users with similar interests or compatible applications at any place, his or her mobile experience is greatly enhanced. Such an interaction that occurs in a coincidental way without any pre-coordination is referred to as an impromptu interaction. The infrastructure-independent mechanisms that support impromptu interactions provide a number of benefits. First, unrelated mobile devices can discover other devices in range and exchange information about their applications. Second, independent groups of communicating devices can utilize different available frequencies to avoid interference with each other.

One embodiment of the invention defines a well-known WiFi ad-hoc network configuration so that, potentially unrelated, nearby nodes can communicate with each other without the use of an access point running in the infrastructure, or independent basic service set (IBSS), mode of WiFi and without coordination between them. In other words, they can tune in to this network, or in the 802.11 terminology, setup the WiFi configuration to discover each other. Once connected to the same WiFi network all peers (e.g., mobile devices) use a common protocol to discover each other and to exchange information about user preferences and exported applications.

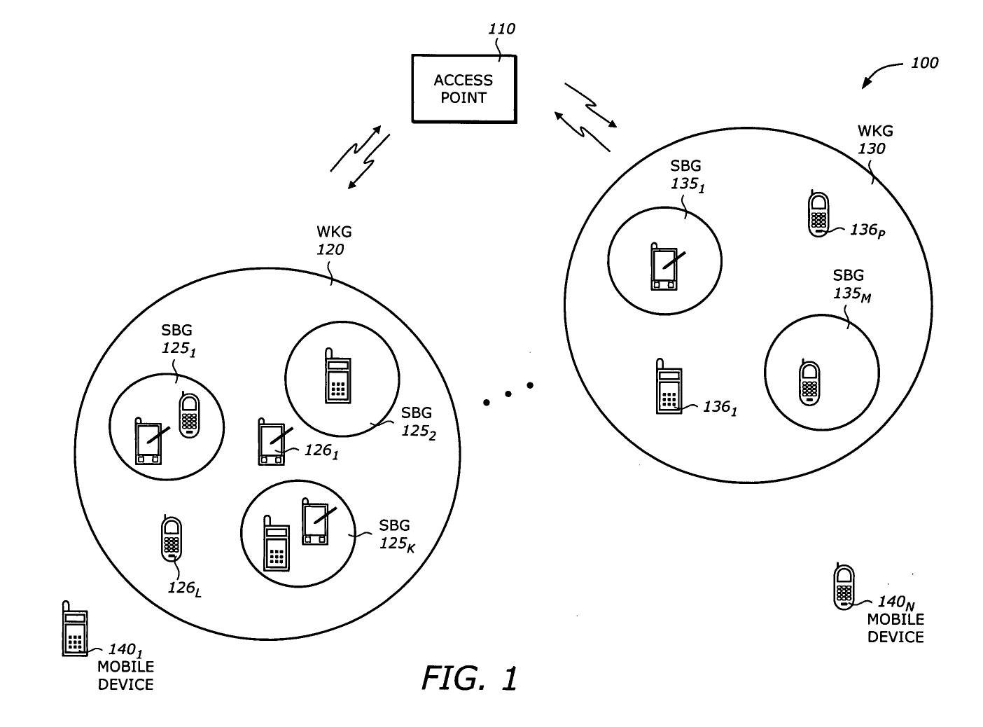

FIG. 1 is a diagram illustrating a system 100 in which one embodiment of the invention can be practiced. The system 100 includes an access point 110, well-known groups 120 and 130, and N mobile devices 140₁ to 140_{N}.

The access point 110 is a device or equipment that provides public wireless broadband network to mobile devices through a wireless local area network (WLAN). It is usually referred to a hotspot and is often located in heavily populated places such as airports, restaurants, convention centers, hotels, etc.

Each of the WKGs 120 and 130 is a physical area that corresponds to the radio range of devices that joined this network. Devices that are in range of WKG 120 and/or 130 may decide at anytime to configure their WiFi card with the WKG WiFi configuration, join the WKG, and be able to interact with other devices in radio range that have setup the same configuration. In a WiFi network, the well-known network configuration may include the SSID and the encryption key. The WKGs 120 and 130 are within the range covered by the access point 110. Users having mobile devices within the range of the WKG 120 or 130 may join in to interact with each other even without knowing each other. Two WKGs 120 and 130 are used for illustrative purposes. A typical system 100 may have one or more than one WKGs.

There may be one or more session-based groups (SBG) associated with a WKG. Devices in a WKG create an SBG. After these devices agree on a WiFi configuration to use, and “migrate” to this wireless network, the SBG becomes an independent entity, and can move outside of the physical area covered by the WKG. For example, the WKG 120 includes K SBGs 125₁ to 125_{K} and other mobile devices 126₁ to 126_{L} that do not belong to any SGG. The WKG 130 includes M SBGs 135₁ to 135_{M} and mobile devices 136₁ to 136_{P} that do not belong to any SBG.

The mobile devices 140₁ to 140_{N} are mobile devices that have not yet joined a WKG. Since a WKG may be created and/or joined by any device, anytime, and anywhere, if other devices are within the radio range and in the same WKG, communication may happen. Any of the mobile devices 140₁ to 140_{N} may join any of the WKG if desired. Each of the mobile devices 126₁ to 126_{L}, 136₁ to 136_{P}, and 140₁ to 140_{N} typically contains a mobile processor that can execute instructions or programs to perform tasks as described in the following. Each of them may also be equipped by one or multiple WiFi radios or interface cards.

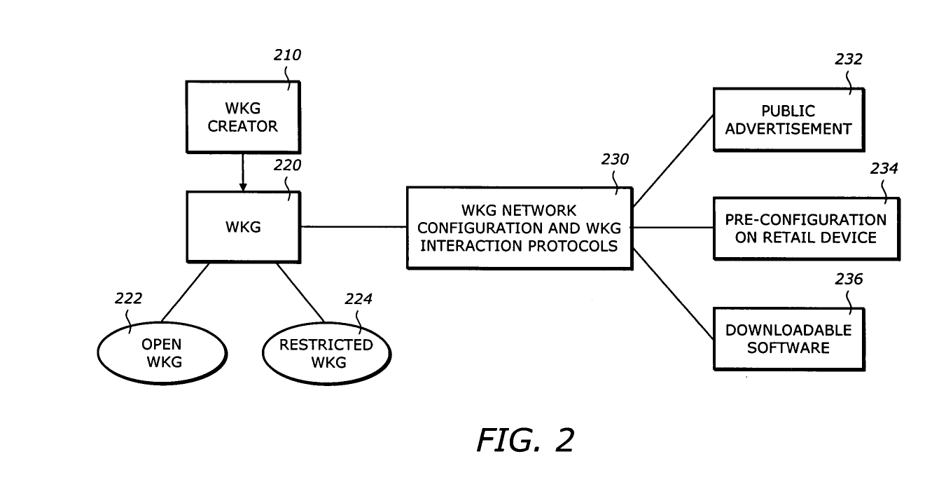

FIG. 2 is a diagram illustrating a well-known group (WKG) according to one embodiment of the invention.

A WKG creator 210 defines a WiFi configuration and creates or instantiates a WKG 220 configuration from the created WiFi configuration. The WKG creator 210 may be any entity such as a company, a government agency, an open source community, or even an individual that has capabilities to provide network configuration for mobile devices. The WKG creator 210 decides the specific WKG WiFi network configuration and WKG interaction protocols 230. The WKG network configuration and the WKG interaction protocols 230 are advertised by the WKG creator to the general public through any means such as public advertisement 232 (e.g., Web site), a pre-configuration 234 of a retail device, and a downloadable software 236.

The WKG 220 is created to support impromptu interactions among unrelated mobile users. Users do not need to know each other in advance and it is not necessary to have pre-coordination for these interactions to take place. A user may obtain the WKG network configuration and interaction protocols 230 by any of the above means to configure his or her mobile device to be able to generate within the WKG 220. The WKG 220 may be an open WKG 222 or a restricted WKG 224. The open WKG 222 has no access control. For example, the WKG does not specify any wireless equivalent privacy (WEP) key in the WiFi configuration. The restricted WKG 224 has access control to allow only users selected by the WKG creator. For example, a company may want to restrict its WKG to its devices for digital rights management (DRM) and authentication purposes in order to restrict denial of service attacks (e.g., spam) or the sharing of inappropriate content.

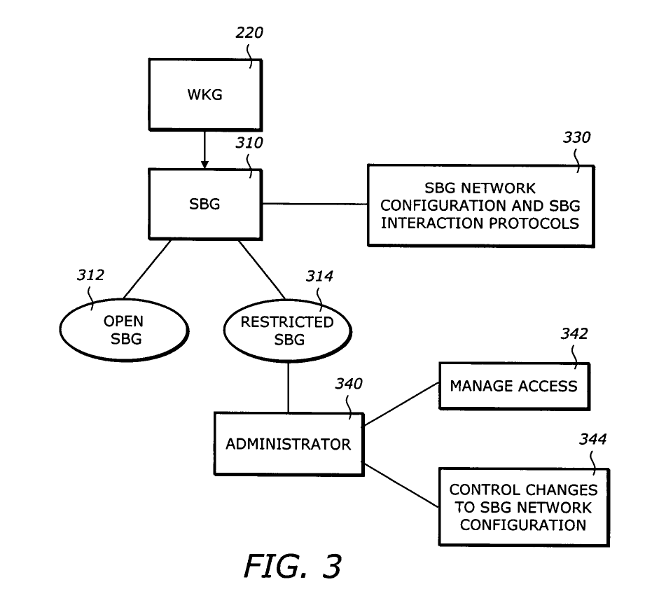

FIG. 3 is a diagram illustrating a session-based group (SBG) according to one embodiment of the invention.

The SBG is created from a WKG. For example, an SBG 310 is created from the WKG 220. The SBG 310 is created for many reasons. For example, it may be created to avoid the noisy WiFi frequency used by the WKG, or to provide a private session for security reasons, or to avoid processing data from other devices.

The SBG 310 is typically a group created by users for a specific purpose that is limited in terms of lifetime, membership, or applications that it supports. The SBG 310 also has a WiFi configuration, and a set of interaction protocols 330. Unlike the WKG 220, the SBG 310 only exists at one specific physical location. The group in the SBG 310 may move as its members are mobile but the SBG 310 is only one set of communicating devices in range of each other.

The SBG 310 is different from the WKG 220 in many aspects. Its main purpose is to support a particular session (i.e., associated with an application's session or to a group of interacting devices). Information pertaining to the SBG 310 is not well known, but rather advertised as group information on the WKG 220. The SBG 310 has a finite lifetime and is dynamically created.

The SBG 310 may be an open SBG 312 or a restricted SBG 314. The open SBG 312 may use a well-known encryption key or no encryption key at all so that any other device or user can join this SBG. The restricted SBG 314 may use a dynamically created encryption key to control who is allowed to join the group. The difference between the restricted WKG 224 (FIG. 2) and the restricted SBG 314 is that members of the restricted SBG 314 can control who else can access or join this group while for the restricted WKG 224, membership is only controlled by the WKG creator 210 (FIG. 2) and not by the actual members. In most instances, a WKG is open and an SBG is restricted.

In the open SBG 312, no user is able to control who can join the group. In the restricted SBG 314, an administrator 340 is selected to manage access 342 or to control changes to the SBG WiFi network configuration 344 (e.g., changes in frequency, channel or the WEP key). The restricted SBG 314 may have one or more administrators. Group members who do not have administrator privileges are called regular members. The administrator 340 may use the group management protocols from the interaction protocols in order to grant or revoke access to the group to another host, and modify the WiFi configuration of the group.

Usually a device joins a WKG and when necessary it will migrate to an SBG. The WKG creator defines a well-known ad-hoc network configuration and a set of interaction protocols to be used by devices when joining this group. When a device or user creates an SBG, a new ad-hoc network configuration and a set of interaction protocols are also required. In theory, any set of interaction protocols supported by the device can be chosen. However, if choosing a different set of interaction protocols than the ones currently in use, problems may arise. For example, if a user in the WKG of company A decides to start an SBG with interaction protocols from company B, the following problems may occur: (1) Users in the WKG of company A may want to join this SBG but are unable because they do not support company B's interaction protocols, (2) Another application already running on the user's device cannot adapt to use company B's interaction protocols, (3) The format of the advertisements in the WKG of company A cannot be transcoded into company B's format. It is therefore unlikely that users will specify a different set of interaction protocols from the WKG, when creating an SBG. Thus, usually an SBG “inherits” its interaction protocols from the WKG.

As a user turns his/her device on, and searches for possible people or devices to interact with, the device joins the default WKG of the user. This can be an open or a restricted WKG depending on the configuration set by the user. The user typically obtains the WKG network configuration and the set of WKG interaction protocols from the WKG creator. Joining an open WKG only depends on the ability of the device to support the interaction protocol used with this WKG. For a restricted WKG, the full WiFi configuration is created on demand by the device. For example, some module on the device may dynamically create a WEP key based on the group's BSSID. After a user has joined a WKG, and after the initial discovery of devices and applications has taken place, the device also presents to the user the list of SBGs in the vicinity that are advertised on the WKG or SBGs that it received an advertisement for and that are still valid. As SGBs are created, terminated, enter or leave the vicinity, this list will change to reflect the current state. This list may include SBGs that have no members in them yet (e.g., created but not yet used). A user can request to join an SBG. There are no restrictions for a device to join an open SBG but in the case of a restricted SBG, the device has to be granted the access to it. Membership of a restricted session-based group can be fixed at creation time so that no new member can join, may require a registration process to some Internet service in order to obtain the complete WiFi configuration, or may be dynamically granted by current members of the group. It is therefore important for a device to know the access method for joining a restricted SBG. This information is included in the SBG advertisement. While any migration of devices between the different kinds of ad-hoc groups (WKG or SBG) is possible, devices mainly migrate (1) from open WKG to open or restricted SBG and vice-versa, and (2) from restricted WKG to restricted SBG, and vice-versa

When exiting an SBG whether voluntarily or not, the device most likely returns to the originating WKG. This happens because the device migrated from this WKG and most likely uses the same set of interaction protocols. In such a case, applications will not face problems of having to adapt to a different set of interaction protocols.

A group may partition due to devices moving in opposite directions. In the case of a WKG, group partitioning appears as if some devices and their applications have left. Interacting applications should support such disconnections as normal behavior. A WKG may be perceived as an island. Users on different island may not be able to communicate with each other. When devices in two WKG come in network range, the two islands merge and each device notices new devices and applications. Open SBGs act similarly to WKG regarding partitioning and merging. For restricted SBGs however, group partitioning results in different groups being created. It is up to the creator of the interaction protocols (i.e., creator of a WKG) to define the potential behaviors of the administrators and regular nodes when group membership evolves, and how partitioned SBGs should act.

Partitioning and/or merging of SBGs also depends on the existence of an administrator. In most cases, SBGs are created either (1) with a single node being the administrator (e.g., clients and a server) or (2) with all nodes being administrators (e.g., peer2peer). In the first case, the island with the administrator continues to interact as before while in the island(s) without the administrator, regular nodes exit the SBG. In the second case, each island continues to operate independently. In this case, each island can decide to remain as an island of the original SBG in order to potentially merge again later on, or can decide to become a new SBG on its own. In the first case, the WiFi configuration stays unchanged for the rest of the SBG's lifetime. In the second case, the islands should generate a new WiFi configuration and distribute it to their members. A limitation of the first case is that it becomes impossible to eject a user from the SBG.

A summary of the WKG and SBG is depicted in Table 1.

TABLE 1
Ad-hoc WKG and SBG

| | Open | Restricted | Characteristics |
|---|---|---|---|
| WKG | anybody can join | administrator | is static and maintained |
| | no WEP | selects who can join | by a provider, |
| | | restricted by WEP | community, or standard |
| | | (or other means) | ubiquitous |
| SBG | anybody can join | member(s) select | is created dynamically |
| | no WEP | who can join | and maintained by users |
| | | restricted by WEP | limited (time, |
| | | (or other means) | applications, |
| | | | membership) |
| | | | only at one location |

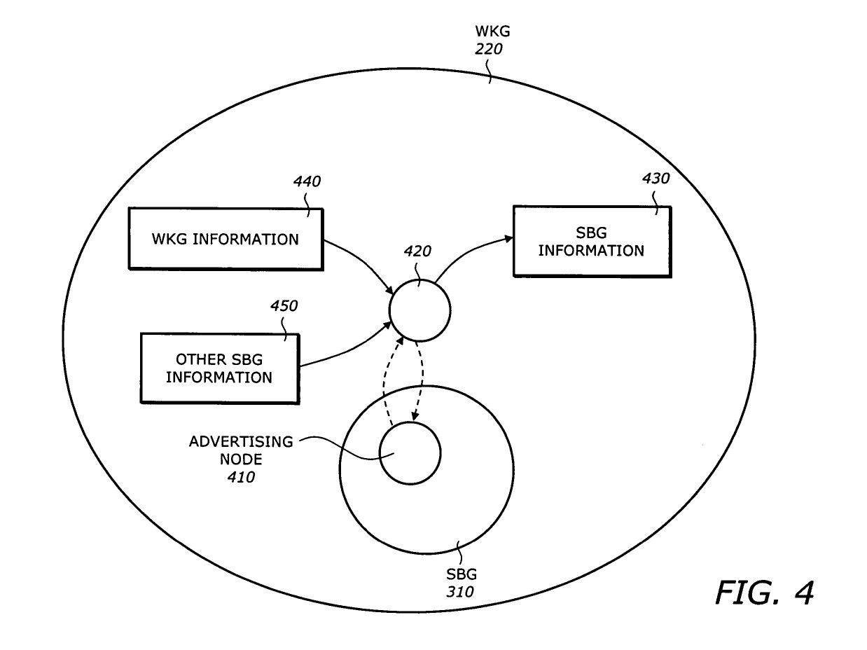

FIG. 4 is a diagram illustrating an advertisement protocol according to one embodiment of the invention.

Since different ad-hoc groups at the same location are using different WiFi configurations, a host in one ad-hoc group cannot communicate with another host in network range but connected to another ad hoc group. Therefore, when some devices in a WKG create and SBG and migrate over to it, these devices and their applications will no longer be accessible to the devices that stay in the WKG. Similarly, the devices in the newly created SBG will not be able to access the devices and applications on the WKG or on different SBGs.

To let devices find out about other groups in the vicinity, an advertisement protocol is used to relay information about devices and applications between SBGs and WKGs. With the advertisement protocol, the following things are possible: (1) information on SBGs can be advertised in WKG, (2) devices in SBGs can learn about devices and applications in the WKG, and (3) devices in SBGs can learn about other SBGs in the vicinity also being advertised in the WKG.

The WKG 220 has WKG information 440 and other SBG information 450, The SBG 310 includes an advertising node 410. The advertising node 410 is selected by the administrator(s) of the group based on one or more criteria. Examples of these criteria include the trustworthiness of the node, the access versatility of the device (e.g., having multiple WiFi cards).

The advertising node 410 collects the information on the SBG 310 such as the SSID, the membership, the interaction protocols used, and the login procedure. The advertising node 410 periodically joins the parent WKG 220 to become node 420 to advertise the group information. Then, the node 420 collects information about the devices and applications on the WKG and potentially other nearby SBGs. Thereafter, the node 420 switches back or return to the SBG 310 to become the node 410, and then advertises the collected information while being the node 420.

If the advertising node 410 has only one radio, it is disconnected from the SBG 310 in order to send the advertisement on the WKG 220. While doing this, the ad-hoc WiFi configuration may change and connections for applications that are running may break. It is therefore important for the applications as well as the interaction protocols to cope with these occasional disconnections. For example, a mechanism that maintains the node 410 in the SBG 310 while simultaneously being the node 420 in the WKG 220 may be used. Any other mechanism that prevents the disconnection may also be used.

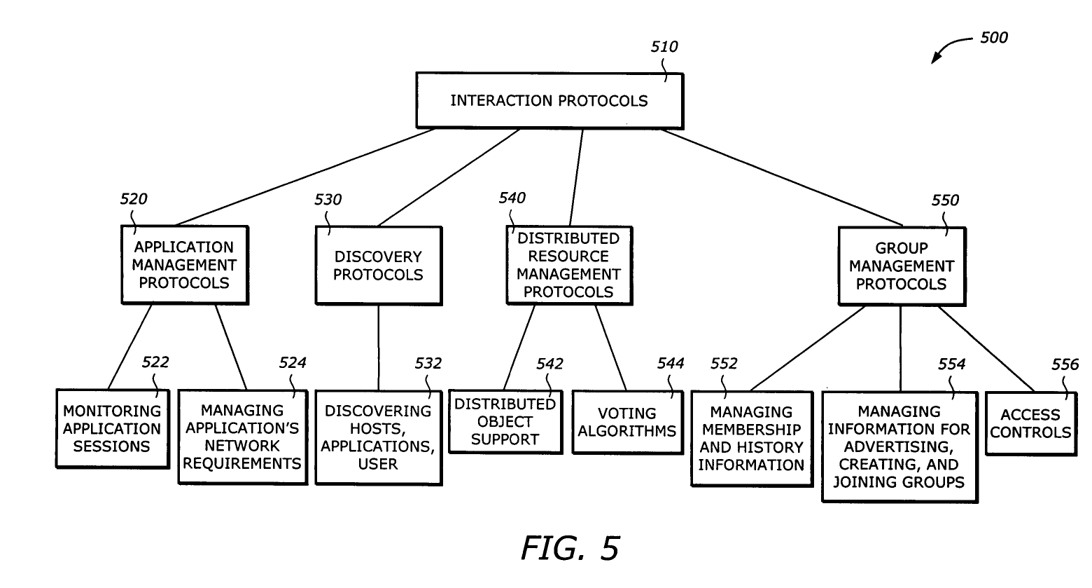

FIG. 5 is a diagram illustrating a set of interaction protocols according to one embodiment of the invention. The interaction protocols 510 include application management protocols 520, discovery protocols 530, distributed resource management protocols 540, and group management protocols 550.

The application management protocols 520 provide support for two main tasks: monitoring application sessions 522 and managing applications' network requirements 524. The WKG creator defines, along with the interaction protocols, an application program interface (API) that applications use to access them. Using the interaction protocols the complexity of the applications and the redundancy of network messages being exchanged between devices can be reduced. The application management protocols allows an application to (1) learn about the current status of the device (e.g., network configuration and state, other applications running on the device), and its environment (e.g., other devices in the vicinity and their active applications), (2) advertise itself to other applications and devices, (3) monitor the network conditions and adapt accordingly, (4) create an SBG when required, and (5) register their communication needs with other devices so that a user that decides to migrate will be aware of the potential problems.

It is up to a WKG creator to define the application oriented features (e.g., events, naming) of the interaction protocols, and the API offered. At the minimum, the API should provide ways for the applications to register and discover others, and also to create SBGs. A more complete solution would provide, for example, a central event heap or a voting mechanism so that distributed applications can coordinate more easily.

The discovery protocols 530 provide discovering hosts, applications, and user 532. When connecting to an ad-hoc group, a user may want to learn about other devices in the area, who their user/owner is, and of the applications they support. The discovery protocols 530 and registries are necessary for this kind of interaction and passing of this information to the mobile device the user is carrying. The goal of the interaction protocols 510 is to enable interaction between mobile users. To do so, information is exchanged about other ad-hoc groups in network range that a user may be interested in joining. The extent of the information transmitted, and how this information is encoded in the messages is decided by the creator of the interaction protocols. As an example this information may include (1) Device: hostname, display properties, storage capabilities, etc., (2) User: nickname, mood/preferences, icon/photo, public keys, etc., (3) Applications: name, WiFi configuration, login procedure, set of interaction protocols used hosts, users and applications currently on this group.

The discovery protocols 530 have the following features: (1) distributed architecture: For WKGs and most SBGs, no assumption can be made on the relationship between peer devices, therefore no central point of control can be assumed. Each device has the same rights and responsibilities. Protocols should therefore be fully distributed and support the disappearance of any number of devices; (2) security: In ad-hoc groups, any member can eavesdrop on communication between other members and any member can attack any other member. Furthermore, since WiFi security is weak, devices outside the group may potentially eavesdrop on communications. Complete trust of other members should not be assumed; and (3) Privacy: Interaction protocols should be careful about the data being exchanged because it can identify the user.

As part of the interaction protocols modules, the WKG creator also defines a set of protocols used by other interaction protocols modules for distributed communications and coordination. They include basic functionality like naming, events locks, messaging and can also include higher level functionality such as shared state or voting. The distributed resource management protocols 540 include support for distributed object 542 and voting algorithms 544. These distributed resources can also be used by applications.

The group membership protocols 550 include membership and history management 552, advertisement and creation management 554, and access control 556. The membership and history management 552 includes managing the history of the group in terms of membership, administrators, or applications, but also WiFi configuration, interference information or beacons. The access control 556 controls who can participate in the group. This means allowing new members to join but also ejecting existing members when necessary. While access control is not necessary for the effective operation of a WKG, it is important for the creator of a WKG to define the set of login protocols that devices should support. An important role of the administrator is to select which device to send out advertisements about the SBG to the WKG. Finally, the administrator monitors the group's condition in order to adapt the SBG to the environment (e.g., interference, group partitioning). In order to control the membership of a group, the administrator can generate a new WiFi configuration and distribute it to the authorized devices in the group. The administrator can also generate a new WiFi configuration with a different frequency to use if the current one is experiencing too much interference. In most cases, there is either only one administrator in an SBG (e.g., client/server type of application such as media server/player) or all members of the group are administrators (e.g., distributed/P2P sharing among friends). In the latter case, depending on the group's policy any administrator can take action (e.g., allow a new member to join the group), or a voting mechanism can be used between multiple administrators (e.g., majority or unanimous policies).

The advertisement and creation management 554 performs group advertisement. Two approaches may be considered for groups advertisement: (1) passive discovery: it is the responsibility of the hosts in the SBG to periodically advertise the group on the WKG. One or more hosts are selected and, after the SBG information has been collected, they migrate to the WKG and send advertisement messages, and (2) active discovery: hosts on the WKG periodically scan frequencies for SBGs in range and collect relevant information directly from them.

Active discovery puts a heavy burden on devices on the WKG group (e.g., coordination for deciding which host has to collect the information) but more importantly, because of encryption potentially used by devices in the SBG, they may not be able to join an SBG and collect the necessary information. Therefore, passive discovery may be desirable.

As part of the advertisement protocols, the WKG creator defines how SBG advertisements are maintained so that new members of the WKG can immediately learn about SBGs in the vicinity, and SBGs can learn about others SBGs in the vicinity. In order to maintain this information, it is necessary to define how members of the WKG maintain the advertisements, for how long they are maintained, and how they are propagated to members of the WKG. A problem for devices in an SBG is when there are no devices in the WKG they advertise to at their current physical location. In that case, the advertisement of the SBG is not maintained by any other host and there is no need for the SBG to advertise itself. An SBG may pause its advertisements if there are no devices on its WKG and resume as soon as the WKG is detected.

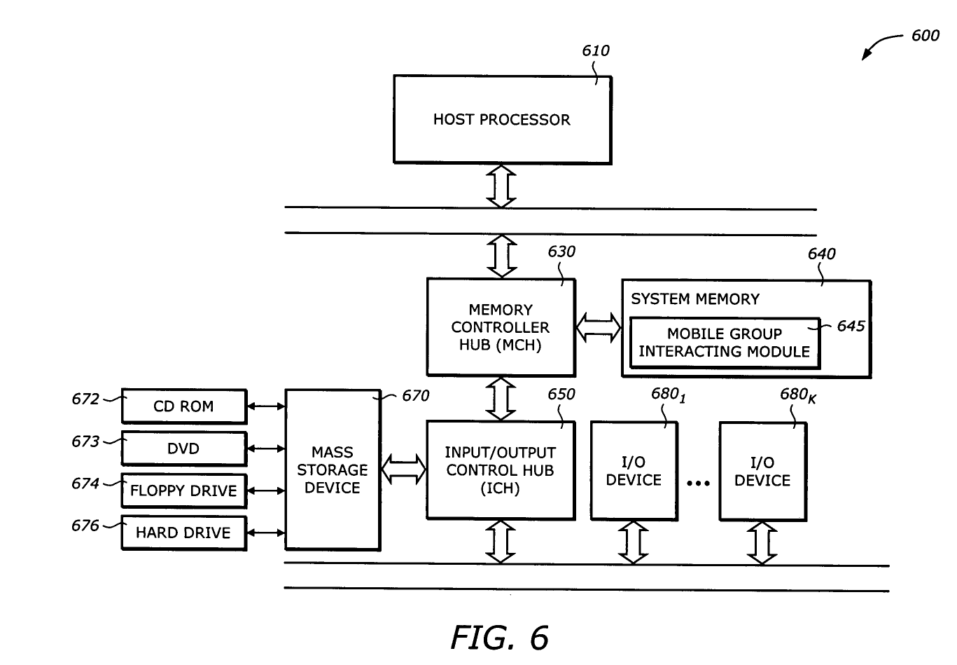

FIG. 6 is a diagram illustrating a system 600 in which one embodiment of the invention can be practiced. The system 600 includes a host processor 610, a memory control hub (MCH) 630, a system memory 640, an input/output control hub (ICH) 650, a mass storage device 670, and input/output devices 680₁ to 680_{K}. Note that the system 600 may include more or less elements than these elements.

The host processor 610 represents a central processing unit of any type of architecture, such as embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The MCH 630 provides control and configuration of memory and input/output devices such as the system memory 640 and the ICH 650. The MCH 630 may be integrated into a chipset that integrates multiple functionalities such as the isolated execution mode, host-to-peripheral bus interface, memory control.

The system memory 640 stores system code and data. The system memory 640 is typically implemented with dynamic random access memory (DRAM) or static random access memory (SRAM). The system memory may include program code or code segments implementing one embodiment of the invention. The system memory includes a mobile group interacting module 645. Any one of the elements of the mobile group interacting module 645 may be implemented by hardware, software, firmware, microcode, or any combination thereof. The mobile group interacting module 645 may include the creation of SBG, network configuration and interaction protocols as discussed above. The system memory 640 may also include other programs or data which are not shown, such as an operating system.

The ICH 650 has a number of functionalities that are designed to support I/O functions. The ICH 650 may also be integrated into a chipset together or separate from the MCH 130 to perform I/O functions.

The mass storage device 670 stores archive information such as code, programs, files, data, applications, and operating systems. The mass storage device 670 may include compact disk (CD) ROM 672, a digital video/versatile disc (DVD) 673, floppy drive 674, and hard drive 676, and any other magnetic or optic storage devices. The mass storage device 670 provides a mechanism to read machine-accessible media. The machine-accessible media may contain computer readable program code to perform tasks as described above.

The I/O devices 680₁ to 680_{K} may include any I/O devices to perform I/O functions. Examples of I/O devices 680₁ to 680_{K} include controller for input devices (e.g., keyboard, mouse, trackball, pointing device), media card (e.g., audio, video, graphics), network card, and any other peripheral controllers.

Elements of one embodiment of the invention may be implemented by hardware, firmware, software or any combination thereof. The term hardware generally refers to an element having a physical structure such as electronic, electromagnetic, optical, electro-optical, mechanical, electromechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc that is implemented or embodied in a hardware structure (e.g., flash memory, ROM, EROM). Examples of firmware may include microcode, writable control store, microprogrammed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable ROM (EROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described in the following. The machine accessible medium may also include program code embedded therein. The program code may include machine readable code to perform the operations described above. The term “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

Additional issues include WiFi network, ad-hoc and infrastructure modes, WKG software, interaction protocols implementation, access control, security, and administrative policies.

Using WiFi Ad-Hoc and infrastructure modes: Ad-hoc networking can be implemented using WiFi technology, by setting nodes in IBSS mode, so that device can communicate directly to each other. It is an alternative to the managed or infrastructure mode where all nodes communicate via an access point. Thus, WiFi ad-hoc mode does not require a central point in charge of controlling the access to the medium and all the packets are sent directly to all other nodes. In the case of an SBG where only one member is an administrator, a way to implement such a group is to use the infrastructure mode of 802.11. This, however, requires the administrator device to be able to act as an access point, and also adds the burden of retransmitting all the packets. It, however, simplifies access control and also simplifies any dynamic change to the WiFi configuration (e.g., change of channel). It is necessary to evaluate the cost/benefits of this alternative in terms of bandwidth and delay, network performance, power consumption, and security.

WiFi Network Range: Ad-hoc routing is not considered in the invention. Devices only communicate with other devices that are within their network range. It may then be the case that a device B in the middle of 2 devices A and C can interact with both of them but that A and C cannot interact together. Applications being deployed in such system should therefore take into account that devices may have a different view of a group. For example, a device in a WKG may receive an advertisement about an SBG that is not in its network range.

Devices with Multiple WiFi Radios: At least one host per SBG has to be able to periodically join the WKG in order to send the group advertisement. If the selected host has to migrate (only one card), it leads to communication with other peers in the SBG being broken and therefore requiring more complex communication management for the applications. If the advertising device is equipped with multiple WiFi radios, it becomes possible to keep one wireless interface on the SBG and use another to periodically send the advertisements on the WKG. It is also possible for such device to be connected on multiple groups at the same time (e.g., WKG and SBG).

Group Information in WiFi Beacons: One or more devices in an SBG need to periodically migrate to the WKG in order to advertise their group, its devices, and its services. This means that, unless the device has multiple WiFi cards, it needs to change its WiFi configuration and hence, breaks existing communication with other SBG members. Another approach for disseminating the information about the group is for the advertisement protocol to use the WiFi beacon and its potential for containing additional data. In this approach, the device sending the WiFi beacon of the SBG collects the group's information and adds it to the beacon. Devices, when receiving a beacon with additional data, can extract it and get the SBG's information. With such dynamic data in WiFi beacons, there is no need for migration and no connection breakdown. The WKG creator would specify the format of the dynamic data to be added to the WiFi beacon. While adding data to the 802.11 beacon frame is part of the standard, this feature is usually not provided by the hardware driver. Another problem is that in a WiFi ad-hoc group, only one host sends the group's beacon. This host should therefore be trusted by the other devices in the group.

WKG Availability: Enough users at a location are needed to keep the WKG alive so that devices can discover each other, users can find content, and an SBG advertisement can be propagated to others SBGs. If all devices in an area are in fact in SBGs and only switch back periodically to the WKG, SBGs may not be able to exchange their advertisements. It is therefore important that devices only create SBG when necessary (e.g., too much interference in the WKG channel).

Hotspots and Ad-Hoc Groups: Hotspots can be part of the system by advertising their network and services as an SBG. If some hotspot's access points are equipped with multiple WiFi cards, they are able to scan their vicinity for users in various WKGs while still servicing their primary network. If a user is interested in the services provided (e.g., Web access), he can decide to migrate to the hotspot network and register to it.

WKG software issues may include WKG software deployment, configuration tools and libraries, WKG and WiFi configuration.

WKG Software Deployment. WKGs are similar to the current IM systems as competing companies provide their own protocols and client software that can connect to their system (e.g., AOL IM, Yahoo Messenger, MSN Windows Messenger). In our case, each WKG creator may distribute the necessary software for joining the WKG and discovering other devices and applications. Examples of how a well-known ad-hoc group can be deployed are: (1) a user defines a well-known configuration for his community and advertises it locally at the mall and stores downtown via posters and on a web site, (2) Sony CLIEs ship with a well-known configuration to share music files securely with proper DRM, and (3) Yahoo publicizes a well-known configuration on its web site with the relevant applications to be used worldwide. To differentiate with others, it becomes important to provide the most efficient or effective interaction protocols at the same time providing unique value added applications.

WKG Configuration Tools and Libraries: Applications on a device use the WKG software modules not only to register themselves and learn about peer applications or devices in a network, but also to notify the WKG modules of their ongoing communicating session. Furthermore, if defined by the WKG creator, the applications can also rely on different distributed resources such as eventing or messaging to better handle the disconnections or migration. In addition to the libraries implementing the interaction protocols, interacting applications also need libraries to manage the network interfaces: (1) Enumerating interface, which one are WiFi, (2) Retrieving/configuring current WiFi configuration, (3) Retrieving networking statistics (e.g., wireless signal strength), and (4) Scanning other WiFi frequencies and collecting beacon information. The user is able to select which WKG to join and when, and is aware of the interactions taking place with his device (e.g., which application, with whom). The user is also able to select which applications should be enabled for different networks, locations, or time of the day.

WKG and WiFi Configuration: A device may support multiple WKG (e.g., by having multiple WKG client software installed), and applications on the device may support multiple WKGs' interaction protocols. However, if the device only has one WiFi card, it only can join one WKG at the same time. This is because a WKG is associated with (1) a specific set of interaction protocols and (2) a WiFi configuration. WiFi configurations are different for each WKG. Typically only one set of interaction protocols is used in a WKG or a SBG. There may be the following problems: (1) devices in a WKG will not receive the advertisements from all the SBGs in the vicinity since some of them may use different interaction protocols and advertise themselves in different WKGs and (2) two device with the same application are not able to interact if they are in different WKG as they cannot discover each other (even if the devices and the application both support the same sets of interaction protocols). Requiring SBGs to advertise on all WKGs is too costly for the advertising node (e.g., it will be too often disconnected from the SBG) and may even be impossible (e.g., the advertising device does not support all WKGs interaction protocols). Implementing a bridging protocol between WKGs may also be too costly and may not be in the interest of WKG creators (e.g., Yahoo, Microsoft, Sony, etc.). A solution is to define a specific WiFi configuration as being a common configuration for all WKGs. Devices joining this WiFi configuration would start the interaction protocols that they support, potentially more than one, and would therefore be able to interact with all peers in the vicinity. This however requires all WKG creators to agree on one configuration. Such agreement is influenced heavily by politics, business, and strategy. Another issue is that each device will also receive and eventually process network messages from the different interaction protocols and lead to duplications of services (e.g., device or application discovery).

The interaction protocols deployed on the WKG are used to exchange information about devices, applications, users, and content in the group. Typically there is only direct communication between peers (i.e., no routing) and because of range and radio limitations, it will reach a maximum in the order of a few hundred (100-200) hosts. However, the number of participants can vary very quickly. The main problem for the interaction protocols is then the rate at which hosts join and leave. This frequency can potentially be very high, since a large number of users may suddenly leave or join in time (e.g., people crossing the main intersection in busy Shibuya, Tokyo). The interaction protocols needs to be completely distributed because no device is guaranteed to remain in a location, and devices that disappear may in fact continue to search for others on the well-known ad-hoc group.

Multicast and Interaction Protocols: The use of network multicasting technology is also preferable, at least for the initial device discovery. Collecting user and application information of nearby devices may however use either multicast or unicast, depending on the environment (e.g., number of hosts, degree of interference). It should be noted that the well-known ad-hoc group is a best effort scheme to discover nearby devices and applications (i.e., a device is not always guaranteed to discover peers even though they may be in range).

Access Control and Security The 802.1x standard has been designed for access point authentication when the user is not aware of the complete configuration (e.g., dynamic WEP keys). In this standard, specific unencrypted packets (e.g., EAP) are sent and intercepted by an access point. These packets contain user identification as well as certificates, shared secrets, or encrypted passwords. The access point then forwards this information to an authentication server and, if successful, accepts the new user and returns the correct WEP key to it. The client can then associate properly with the access point. In one embodiment of the invention, such standard can also be applied. It would require the administrator(s) of a group to also intercept specific unencrypted packets used for authenticating in ad-hoc groups sent by clients. The administrator would then decide to grant or deny access and respond to the client. This method requires the administrator device to be able to process all the unencrypted messages sent on the WiFi group and process these EAP-like packets. Administrator nodes should also maintain the data necessary to process the authentication.

Mobile Device Security: Some security problems are: (1) Attacks: denial of service, flooding (e.g., causing excessive and malicious interference or congestion to those nearby), (2) Trusted Devices: what devices can be trusted to interact with?, (3) Port Filtering: Since a user may potentially interact with anyone in a WKG/SBG, protection via port filtering or firewalls is important, (4) Out of band authentication or license exchange: use of cellular connectivity, or other types of network connectivity to retrieve additional authentication information or licenses. Security for well-known ad-hoc groups is especially critical. Deploying a daemon or resident program that automatically shuts down all network ports when migrating to a well-known ad-hoc group maybe sensible. This daemon can manage which applications the users wants to advertise, the necessary security levels, which applications the user wants to discover and join open up relevant network ports accordingly.

Administrative Policies: Session-based ad-hoc groups can impose administrative policies to restrict membership. Several different administrative policy scenarios may be outlined as follows:

Single Administrator Model: Audio server. A user shares the songs on his CLIE. He starts as the owner (e.g., single administrator) of the group. People nearby request to join his session-based ad-hoc group in order to listen to his songs. The CLIE owner decides which person is able to join. If at some point he wants to eject one or more users from the group, he selects a new WEP key and advertises it only to the devices that remain authorized. At some point, because the CLIE user moves, 2 client users are out of range. As the owner of the ad-hoc group has “left”, these client users fallback to the well-known ad-hoc group.

Multiple Administrator Model: A group of friends at the university sharing photos. A new person joins the group. A pop-up window appears on each member's device. As they all agree, the new person is authorized and given full access to the group. Some of the friends in the group decide to go to the cafeteria but keep sharing, annotating photos while the rest of the group stay and continue also to share and annotate photos. The ad-hoc group partitions into two separate groups (e.g., each group will see the other group members “disappear”) and each will continue independently.

No Administrator Model: Fully distributed gaming.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

1. A method comprising:
creating a session-based ad-hoc group (SBG) within a well-known ad-hoc group (WKG) for impromptu interactions among unrelated mobile users, the WKG having a WKG network configuration and a set of WKG interaction protocols, the SBG having SBG network configuration and a set of SBG interaction protocols; and
advertising information pertaining to the SBG on the WKG.

2. The method of claim 1 wherein creating the SBG comprises
obtaining the WKG network configuration and the set of WKG interaction protocols.

3. The method of claim 2 wherein obtaining the WKG network configuration and the set of WKG interaction protocols comprises obtaining one of a pre-configuration on a retail device, a downloadable client software, and a public advertisement.

4. The method of claim 1 wherein the WKG creating one of an open WKG and a restricted WKG, the open WKG having no access control, the restricted WKG having an access control to selected users.

5. The method of claim 1 wherein creating the SBG comprises:
creating one of an open SBG and a restricted SBG, the open SBG having no access control, the restricted SBG having an access control to selected users.

6. The method of claim 5 wherein creating one of an open SBG and a restricted SBG comprises:
selecting at least an administrator to manage access to the restricted SBG and control changes to the SBG network configuration.

7. The method of claim 6 wherein advertising comprises:
selecting an advertising node according to a criteria within the SBG;
collecting information on the SBG;
periodically joining the WKG to broadcast the SBG information and to collect information on the WKG or a nearby SBG; and
returning to the SBG to advertise the information collected on the WKG to SBG members.

8. The method of claim 1 further comprising:
joining the WKG according to user configuration.

9. The method of claim 8 wherein joining the WKG comprises:
joining the SBG.

10. The method of claim 1 further comprising:
partitioning one of the WKG and the SBG.

11. The method of claim 1 further comprising:
merging the WKG to one other WKG; and
merging the SBG to one other SBG.

12. The method of claim 1 further comprising:
enabling interaction among the unrelated mobile users within the WKG or the SBG using the WKG interaction protocols or the SBG interaction protocols.

13. The method of claim 12 wherein enabling interaction comprises:
managing an application;
discovering at least one of a host, an application, and a user profile;
managing distributed resource; and
managing group information.

14. An article of manufacture comprising:
a machine-accessible medium including data that, when accessed by a machine, causes the machine to perform operations comprising:
creating a session-based ad-hoc group (SBG) within a well-known ad-hoc group (WKG) for impromptu interactions among unrelated mobile users, the WKG having a WKG network configuration and a set of WKG interaction protocols, the SBG having SBG network configuration and a set of SBG interaction protocols; and
advertising information pertaining to the SBG on the WKG.

15. The article of manufacture of claim 14 wherein the data causing the machine to perform creating the WKG comprises data that, when accessed by the machine, causes the machine to perform operations comprising:
obtaining the WKG network configuration and the set of WKG interaction protocols to a general public.

16. The article of manufacture of claim 15 wherein the data causing the machine to perform obtaining the WKG network configuration and the set of WKG interaction protocols comprises obtaining one of a pre-configuration on a retail device, a downloadable client software, and a public advertisement.

17. The article of manufacture of claim 14 wherein the WKG is one of an open WKG and a restricted WKG, the open WKG having no access control, the restricted WKG having an access control to selected users.

18. The article of manufacture of claim 14 wherein the data causing the machine to perform creating the SBG comprises data that, when accessed by the machine, causes the machine to perform operations comprising:
creating one of an open SBG and a restricted SBG, the open SBG having no access control, the restricted SBG having an access control to selected users.

19. The article of manufacture of claim 18 wherein the data causing the machine to perform creating one of an open SBG and a restricted SBG comprises data that, when accessed by the machine, causes the machine to perform operations comprising:
selecting at least an administrator to manage access to the restricted SBG and control changes to the SBG network configuration.

20. The article of manufacture of claim 19 wherein the data causing the machine to perform advertising comprises data that, when accessed by the machine, causes the machine to perform operations comprising:
selecting an advertising node according to a criteria within the SBG;
collecting information on the SBG;
periodically joining the WKG to broadcast the SBG information and to collect information on the WKG or a nearby SBG; and
returning to the SBG to advertise the information collected on the WKG to SBG members.

21. The article of manufacture of claim 14 wherein the data further comprises data that, when accessed by the machine, causes the machine to perform operations comprising:
joining the WKG according to user configuration.

22. The article of manufacture of claim 21 wherein the data causing the machine to perform joining the WKG comprises data that, when accessed by the machine, causes the machine to perform operations comprising:
joining the SBG.

23. The article of manufacture of claim 14 wherein the data further comprises data that, when accessed by the machine, causes the machine to perform operations comprising:
partitioning one of the WKG and the SBG.

24. The article of manufacture of claim 14 wherein the data further comprises data that, when accessed by the machine, causes the machine to perform operations comprising:
merging the WKG to one other WKG; and
merging the SBG to one other SBG.

25. The article of manufacture of claim 14 wherein the data further comprises data that, when accessed by the machine, causes the machine to perform operations comprising:
enabling interaction among the unrelated mobile users within the WKG or the SBG using the WKG interaction protocols or the SBG interaction protocols.

26. The article of manufacture of claim 25 wherein wherein the data causing the machine to perform enabling interaction comprises data that, when accessed by the machine, causes the machine to perform operations comprising:
managing an application;
discovering at least one of a host, an application, and a user profile;
managing distributed resource; and
managing group information.

27. A system comprising:
a well-known ad-hoc group (WKG) for impromptu interactions among unrelated mobile users, the WKG having a WKG network configuration and a set of WKG interaction protocols; and
a session-based ad-hoc group (SBG) within the WKG to allow a user to interact with other mobile users, the SBG having SBG network configuration and a set of SBG interaction protocols, the SBG advertising information pertaining to the SBG on the WKG.

28. The system of claim 27 wherein the WKG is an open or restricted WKG.

29. The system of claim 27 wherein the SBG is an open or restricted SBG.

30. The system of claim 29 wherein the SBG has at least an administrator to manage access to the restricted SBG and control changes to the SBG network configuration.
